(19) United States
(12) Patent Application Publication
(10) Pub. No.: US 2026/0161988 A1
(43) Pub. Date: Jun. 11, 2026

(54) PERFORMANCE IMPROVEMENT OF VARIATIONAL QUANTUM CLASSIFIERS USING LARGE LANGUAGE MODELS

(71) Applicant: Infosys Limited, Bangalore (IN)

(72) Inventors: Shiva Rama Krishna Parvatham, Bangalore (IN); Szymon Glab, Lodz (PL)

(73) Assignee: Infosys Limited, Bangalore (IN)

(21) Appl. No.: 18/962,819

(22) Filed: Nov. 27, 2024

(30) Foreign Application Priority Data
Oct. 1, 2024 (IN) 202441074358

(51) Int. Cl. G06N 10/60; G06F 40/40

(52) U.S. Cl. CPC G06N 10/60; G06F 40/40

(57) ABSTRACT

A system for improving performance of variational quantum classifiers (VQCs) using large language models (LLMs) is provided. Features and classes are extracted from a classification dataset. Weights are assigned to the features based on contribution of the features in class identification. Further, segregation parameters are determined for the features such that a segregation parameter indicates a degree of separation between two classes based on a correlation between two features. A prompt is generated based on the weights, the segregation parameters, current ansatz and feature map of a VQC, a performance metric of the VQC for the current ansatz and feature map, details of hardware executing the VQC, and a number of qubits of the VQC. Using an LLM, a response to the prompt is generated. Further, using the response, the ansatz and the feature map are updated. The update continues until the performance metric is within a desired range.

### RELATED APPLICATIONS

This application claims the benefit of Indian Patent Application No. 202441074358, filed Oct. 1, 2024, which is incorporated herein by reference in its entirety.

### FIELD OF THE DISCLOSURE

Various embodiments of the present disclosure relate generally to variational quantum classifiers. More specifically, various embodiments of the present disclosure relate to performance improvement of variational quantum classifiers using large language models.

### BACKGROUND

A variational quantum classifier (VQC) is a type of quantum machine learning algorithm that leverages the principles of quantum mechanics for classification tasks. The VQC combines the computational power of quantum circuits with machine learning techniques to solve complex classification problems. The VQC includes a parameterized quantum circuit that processes input data, and measurements are taken to yield a predicted classification result. The performance (e.g., accuracy) of the VQC is evaluated, using a cost function (e.g., cross-entropy loss), by comparing the predicted classification result with true labels. The parameters of the quantum circuit are iteratively updated to minimize this cost function and increase the accuracy of the VQC. While the parameters are updated throughout the iterative process, an architecture (e.g., an arrangement of quantum gates, types of quantum gates, or the like) of the quantum circuit remains fixed. Consequently, even after all iterations of the parameter update, the performance improvement of the VQC may be moderate while the computational cost may be significant, thereby leading to a decrease in the overall efficacy of the VQC.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for performance improvement of variational quantum classifiers (VQCs) using large language models (LLMs) are provided substantially as shown in, and described in connection with, at least one of the figures.

The methods and systems disclosed herein include various operations performed by processing circuitry. The processing circuitry may be configured to extract, from a classification dataset, a set of features and a plurality of classes that are identified based on the set of features. A VQC is iteratively trained based on the classification dataset. Further, the processing circuitry may be configured to assign a set of weights to the set of features. A weight, of the set of weights, is assigned to a feature, of the set of features, based on a contribution of the corresponding feature in the identification of the plurality of classes. The processing circuitry may be further configured to determine a plurality of segregation parameters for the set of features. A segregation parameter, of the plurality of segregation parameters, may indicate a degree of separation between at least two classes, of the plurality of classes, based on a correlation between at least two features of the set of features. The iterative training of the VQC may be controlled based on the assigned set of weights and the determined plurality of segregation parameters.

In some embodiments, the processing circuitry may be further configured to obtain a current ansatz associated with the VQC and a set of performance metrics of the VQC for the current ansatz. The iterative training of the VQC may be controlled further based on the obtained ansatz and the obtained one or more performance metrics.

In some embodiments, during an iteration of the VQC training, based on the current ansatz and the classification dataset, an output of the VQC may be generated. Further, the set of performance metrics may be determined based on a comparison of the generated output with a target output of the classification dataset.

In some embodiments, the processing circuitry may be further configured to obtain a set of hardware details of hardware executing the VQC. The iterative training of the VQC may be controlled further based on the obtained set of hardware details.

In some embodiments, the set of hardware details may include at least one of a group consisting of a quantum gate type, a number of quantum parameters associated with a quantum gate, a number of quantum gates, and a number of quantum layers.

In some embodiments, the processing circuitry may be further configured to obtain a count value indicative of a number of qubits associated with the VQC. The iterative training of the VQC may be controlled further based on the obtained count value.

In some embodiments, the number of qubits associated with the VQC may be a function of a number of features associated with the classification dataset.

In some embodiments, to control the iterative training of the VQC, the processing circuitry may be further configured to update, based on the assigned set of weights and the determined plurality of segregation parameters, an ansatz associated with the VQC during each iteration.

In some embodiments, the processing circuitry may be further configured to generate a prompt based on at least one of a group consisting of the assigned set of weights, the determined plurality of segregation parameters, a current ansatz associated with the VQC, a set of performance metrics of the VQC for the current ansatz, a set of hardware details of hardware executing the VQC, and a count value indicative of a number of qubits associated with the VQC.

In some embodiments, the processing circuitry may be further configured to generate, using an LLM, a response to the generated prompt. The generated response may correspond to the updated ansatz.

In some embodiments, the processing circuitry may be further configured to generate, using an LLM, a response to the generated prompt and translate the generated response to a format associated with the VQC. The translated response may correspond to the updated ansatz.

In some embodiments, during an initial iteration of the training of the VQC, the ansatz associated with the VQC may correspond to a real-amplitude ansatz.

In some embodiments, the trained VQC may include a version of the ansatz having the highest value of a set of performance metrics of the VQC.

In some embodiments, the processing circuitry may be further configured to obtain a sampled dataset from the classification dataset.

In some embodiments, to assign the set of weights to the set of features, the processing circuitry may be further configured to execute a random forest operation on the sampled dataset.

In some embodiments, the weight may correspond to a Gini importance value.

In some embodiments, the segregation parameter may correspond to a t-student parameter value.

In some embodiments, the processing circuitry may be further configured to obtain a current feature map associated with the VQC. The iterative training of the VQC may be controlled further based on the obtained feature map.

In some embodiments, to control the iterative training of the VQC, the processing circuitry may be further configured to update, based on the assigned set of weights and the determined plurality of segregation parameters, an ansatz and a feature map associated with the VQC during each iteration.

In some embodiments, the processing circuitry may be further configured to generate a prompt based on at least one of a group consisting of the assigned set of weights, the determined plurality of segregation parameters, a current ansatz and a current feature map associated with the VQC, a set of performance metrics of the VQC for the current ansatz and the current feature map, a set of hardware details of hardware executing the VQC, and a count value indicative of a number of qubits associated with the VQC.

In some embodiments, the processing circuitry may be further configured to generate, using an LLM, a response to the generated prompt. The generated response may correspond to the updated ansatz and the updated feature map.

In some embodiments, the processing circuitry may be further configured to generate, using an LLM, a response to the generated prompt and translate the generated response to a format associated with the VQC. The translated response may correspond to the updated ansatz and the updated feature map.

In some embodiments, during an initial iteration of the training of the VQC, the feature map associated with the VQC corresponds to a ZZ feature map.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic block diagram that illustrates a variational quantum classifier (VQC) system, consistent with disclosed embodiments of the present disclosure;

FIG. 2 is a block diagram of processing circuitry of the VQC system of FIG. 1, consistent with disclosed embodiments of the present disclosure;

FIG. 3 illustrates an example implementation of segregation parameters for four features and two classes, consistent with disclosed embodiments of the present disclosure;

FIG. 4 is a block diagram of a real-amplitude ansatz utilized for an initial iteration of training of a VQC of the VQC system of FIG. 1, consistent with disclosed embodiments of the present disclosure;

FIG. 5 is a block diagram of an updated ansatz utilized for the last iteration of the training of the VQC, consistent with disclosed embodiments of the present disclosure;

FIG. 6 shows an example computing system for carrying out the methods of the present disclosure, consistent with disclosed embodiments of the present disclosure;

FIGS. 7A and 7B, collectively, represents a flowchart that illustrates a method for performance improvement of the VQC, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Conventionally, to improve the performance of a variational quantum classifier (VQC), instead of exclusively updating the parameters of a quantum circuit, an architecture (e.g., an arrangement of quantum gates, types of quantum gates, a number and types of quantum layers, or the like) of the quantum circuit may also be updated. In other words, an ansatz may be updated for each iteration to improve the performance (e.g., accuracy) of the VQC. Conventionally, to determine the updated ansatz (e.g., the arrangement of the quantum gates and the parameters associated therewith), large language models (LLMs) may be utilized. A prompt defined using the description of the task and details of the available hardware may be provided to an LLM, and the output of the LLM may be utilized to update the ansatz. Whilst the aforementioned technique provides advantages over the traditional approach of utilizing a fixed architecture, the performance of the VQC may still not be optimized. The factors defining the prompt may not sufficiently describe the exact requirement, thereby leading to numerous iterations, and in turn, significant computational cost. Additionally, in some scenarios, human intervention may be required to tune the prompt, thereby leading to errors such as bias in task representation, inclusion of inaccurate information about quantum gates, or the like. Such errors may lead to inaccurate results and inefficient utilization of resources.

The present disclosure provides a different approach for improving the performance of VQCs using LLMs. For accurate classification, information about a classification dataset can play an important role. The classification dataset may include features (e.g., inputs) and classes (e.g., outputs) identified based on the features. The features may have varying contributions to class identification. The class identification also depends on the correlation between two or more features. For example, the correlation between two or more features may be utilized to define a degree of separation between the classes. This degree of separation can be indicated by way of a segregation parameter. Therefore, for the classification task, details associated with the contribution of each feature in the class identification and the segregation parameters for the features can be utilized to improve the accuracy of the classification. In the present disclosure, this dataset information is leveraged in designing a prompt. In addition to the dataset information, information related to the task (e.g., an ansatz and a feature map of the VQC), a performance metric of the VQC for the ansatz and the feature map, a number of qubits of the VQC, and hardware details of hardware executing the VQC, may be utilized for designing the prompt. Using an LLM, a response to the prompt may be generated and the generated response may be utilized for updating the ansatz as well as the feature map. The update may continue until the performance metric is within a desired range.

Utilization of the ansatz, that is generated based on a specifically engineered prompt, for the VQC training results in achieving performance improvement with a significant reduction in the number of iterations. The application area of the present disclosure may include any domain that utilizes pattern identification, risk analysis, power optimization, or the like. It is appreciated that the human mind is not equipped to conceptualize and engineer prompts using the classification dataset given its digital interconnectedness.

The present disclosure may allow for performance improvement of the VQC by utilizing the optimized design of the prompt. As the description of the classification dataset is utilized for generating the prompt, the number of iterations required to achieve the desired performance metrics may be significantly less than the number of iterations required for the conventional technique. Consequently, the computational cost associated with the VQC performance improvement technique of the present disclosure may be significantly less than that with the conventional technique. The VQC performance improvement technique of the present disclosure may be sans any human intervention based prompt tuning. Therefore, human errors may also be avoided, leading to a further increase in the performance (e.g., classification accuracy). It is appreciated that the approaches discussed herein improve the technical field of computer network performance by reducing bandwidth usage and increasing system responsiveness.

### Figure Description:

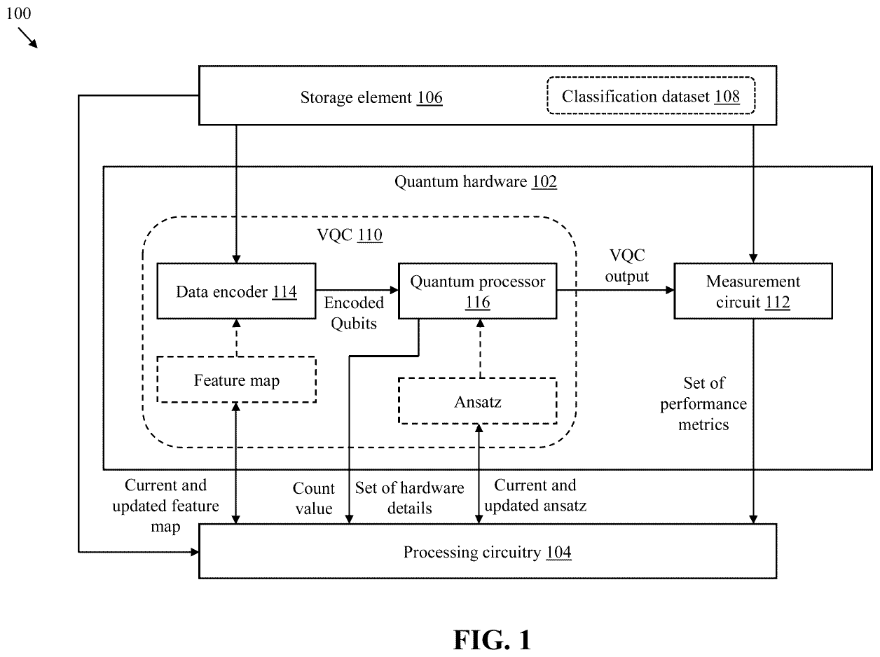

FIG. 1 is a schematic block diagram that illustrates a variational quantum classifier (VQC) system 100, consistent with disclosed embodiments of the present disclosure. Classification tasks are fundamental problems in machine learning and data analysis, where the goal is to categorize input data into several classes. These tasks may be central to numerous applications, including image recognition, spam detection, medical diagnosis, and sentiment analysis. In the present era of big data, a huge amount of data may be required to be processed for executing a classification task. Classical computing has failed to provide a suitable environment for processing ever-growing volumes of big data, due to its limitations in processing speed, scalability, or the like. To overcome these challenges, quantum computing may be utilized.

The field of quantum computing focuses on building computers based on the principles of quantum mechanics, a fundamental theory in physics that describes the behavior of matter and energy at atomic and subatomic levels. Unlike classical computers, which use bits as the smallest unit of information that can be either 0 or 1, quantum computers use quantum bits, or qubits, which can exist in a superposition of states, representing both 0 and 1 simultaneously. Quantum circuits are the computational frameworks of quantum computing, consisting of sequences of quantum gates that manipulate qubits to perform complex calculations. A quantum circuit may begin with an initial state of qubits, apply a series of quantum gates (e.g., functions/operations) to transform these states, and conclude with measurements that extract classical information from the quantum system. The design and execution of quantum circuits can leverage principles such as superposition, entanglement, and interference, enabling them to process information in ways that classical circuits cannot. This may render quantum computers an effective choice for the classification tasks.

A VQC is a notable example of quantum computing being utilized for the classification tasks. The VQC is a type of quantum machine learning algorithm that leverages the principles of quantum mechanics for the classification tasks. The VQC may be considered a hybrid algorithm because it combines the advantages of quantum computing with the optimization techniques of classical computing. The present disclosure describes a VQC implementation where the performance of the VQC is improved using large language models (LLMs).

Referring to FIG. 1, the VQC system 100 may include a quantum hardware 102, processing circuitry 104, and a storage element 106. The quantum hardware 102 and the processing circuitry 104 may correspond to quantum and classical elements, respectively, that are required for the VQC implementation. The storage element 106 may be configured to store a classification dataset 108 associated with a classification task.

The storage element 106 may correspond to hardware storage (for example, hard drive, solid-state drive, or the like) or cloud storage (for example, cloud services) to store the classification dataset 108 persistently. The classification dataset 108 may be a structured collection of data used to train, validate, and test classification algorithms in machine learning. Each entry in the classification dataset 108 may include multiple features that describe an instance, along with a label that indicates the class to which the instance belongs. Such a dataset can be used in a variety of applications, such as image recognition, spam detection, or the like. The classification dataset 108 may play an important role in developing accurate and reliable classifiers (such as VQCs), as they provide the necessary examples to learn patterns and relationships between features and classes.

The quantum hardware 102 may include a VQC 110 and a measurement circuit 112. The VQC 110 may involve the implementation of a parameterized quantum circuit that executes various quantum gates (e.g., functions/operations) on qubits, and the measurement circuit 112 may be configured to extract classical information from the VQC 110 to evaluate the performance of the VQC 110. As illustrated in FIG. 1, the VQC 110 may include a data encoder 114 and a quantum processor 116.

The data encoder 114 may be communicatively coupled to the storage element 106. The data encoder 114 may include suitable logic, circuitry, interfaces, and/or code, executable by the circuitry, that may be configured to map classical data (e.g., the features of the classification dataset 108) into quantum states. A quantum state may be a linear combination of 0 and 1. Thus, the data encoder 114 may be configured to translate classical data inputs into a format suitable for quantum computation. As quantum circuits operate on qubits and cannot directly process classical data, the transformation of the classical data into quantum states may be necessary. Thus, the data encoder 114 may convert classical data, such as numerical features or categorical variables, into quantum states or quantum representations that can be processed by the quantum processor 116 of the VQC 110. The data encoder 114 may thus generate encoded qubits. In an embodiment, the data encoder 114 may be configured to utilize a feature map to perform the data encoding operation.

The quantum processor 116 may be communicatively coupled to the data encoder 114. The quantum processor 116 may include suitable logic, circuitry, interfaces, and/or code, executable by the circuitry, that may be configured to execute quantum operations on the encoded qubits to generate a VQC output. In an embodiment, the quantum processor 116 may utilize an ansatz to generate the VQC output. The ansatz may be a parameterized quantum circuit (e.g., an arrangement of quantum gates with adjustable parameters) that is problem-specific (e.g., architected for the classification task). The ansatz may correspond to a subspace of the space in which the solution is sought. This subspace may be dense in the original space to represent states that are close to an actual problem solution. As a result, instead of searching the whole space, the solution search is executed within the subspace. The ansatz thus reduces the complexity of the problem. The quantum processor 116 may define a quantum gate type, a number of quantum parameters associated with a quantum gate, a number of quantum gates, a number of quantum layers, or the like, that can be utilized in the ansatz. In the quantum processor 116, the encoded qubits may be manipulated based on functions defined by the ansatz to generate the VQC output.

The measurement circuit 112 may be communicatively coupled to the storage element 106 and the quantum processor 116. The measurement circuit 112 may include suitable logic, circuitry, interfaces, and/or code, executable by the circuitry, that may be configured to evaluate the performance of the VQC 110. For example, the measurement circuit 112 may be configured to compare the VQC output of the VQC 110 with a target output (e.g., classes) of the classification dataset 108. Based on a result of the comparison, the measurement circuit 112 may be configured to generate a set of performance metrics of the VQC 110. In an embodiment, the set of performance metrics may include an accuracy of the VQC 110. However, in other embodiments, other performance metrics may be utilized.

In the present disclosure, the VQC 110 may be iteratively trained based on the classification dataset 108. In other words, to train the VQC 110 for classification tasks, the features from the classification dataset 108 may be encoded into the qubits using the feature map and the encoded qubits may be manipulated using the ansatz to generate the VQC output. During an initial iteration of the training of the VQC 110, the ansatz associated with the VQC 110 may correspond to a real-amplitude ansatz, whereas the feature map associated with the VQC 110 may correspond to a ZZ feature map. Further, the VQC output may be compared with a desired class of the classification dataset 108 to determine the accuracy of the VQC training. The aforementioned operations may be iteratively executed until the set of performance metrics of the VQC 110 is within a desired range. The desired range may correspond to a range of values for which the performance of the VQC 110 is considered acceptable. Thus, during an iteration of the VQC training, the VQC output may be generated based on the current ansatz, the current feature map, and the classification dataset 108, and the set of performance metrics may be determined based on a comparison of the generated VQC output with the target output of the classification dataset 108. To optimize the set of performance metrics, in the present disclosure, LLMs may be utilized. For example, in the present disclosure, during each iteration, an LLM may be utilized to update the feature map and the ansatz. Such iterative update of the feature map and the ansatz may be controlled by the processing circuitry 104.

The processing circuitry 104 may be communicatively coupled to the storage element 106 and the quantum hardware 102 (e.g., the VQC 110 and the measurement circuit 112). The processing circuitry 104 may include suitable logic, circuitry, interfaces, and/or code, executable by the circuitry, that may be configured to control the iterative training of the VQC 110. For example, the processing circuitry 104 may be configured to extract, from the classification dataset 108, a set of features and a plurality of classes that are identified based on the set of features.

The processing circuitry 104 may be further configured to assign a set of weights to the set of features. A weight, of the set of weights, may be assigned to a feature, of the set of features, based on a contribution of the corresponding feature in the identification of the plurality of classes. In an embodiment, the processing circuitry 104 may be configured to obtain a sampled dataset from the classification dataset 108. Further, to assign the set of weights to the set of features, the processing circuitry 104 may be further configured to execute a random forest operation on the sampled dataset. In an embodiment, the assigned weight may correspond to a Gini importance value. The processing circuitry 104 may be further configured to determine a plurality of segregation parameters for the set of features. In an embodiment, the sampled dataset may be utilized for the determination of the plurality of segregation parameters. A segregation parameter, of the plurality of segregation parameters, may indicate a degree of separation between at least two classes, of the plurality of classes, based on a correlation between at least two features of the set of features. In an embodiment, the segregation parameter may correspond to a t-student parameter value. The set of weights and the plurality of segregation parameters can thus provide the description of the classification dataset 108.

The processing circuitry 104 may be further configured to obtain a current ansatz (e.g., a current version of the ansatz) and a current feature map (e.g., a current version of the feature map) from the quantum hardware 102 (e.g., the VQC 110). The processing circuitry 104 may be further configured to obtain the set of performance metrics of the VQC 110 for the current ansatz and the current feature map from the quantum hardware 102 (e.g., the measurement circuit 112). Further, the processing circuitry 104 may be configured to obtain a set of hardware details of hardware (e.g., the quantum processor 116) executing the VQC 110. In an embodiment, the set of hardware details may include a quantum gate type, a number of quantum parameters associated with a quantum gate, a number of quantum gates, a number of quantum layers, or the like. Further, the processing circuitry 104 may be configured to obtain a count value indicative of a number of qubits associated with the VQC 110. In an embodiment, the number of qubits associated with the VQC 110 may be a function of a number of features associated with the classification dataset 108. The processing circuitry 104 may obtain the set of hardware details and the count value from the quantum processor 116. In an embodiment, the quantum processor 116 may include a storage circuit (not shown) that may be configured to store the count value and the set of hardware details.

Based on the assigned set of weights, the determined plurality of segregation parameters, the current ansatz and the current feature map associated with the VQC 110, the set of performance metrics of the VQC 110 for the current ansatz and the current feature map, the set of hardware details, and the count value, the processing circuitry 104 may be configured to control the iterative training of the VQC 110. Thus, the iterative training of the VQC 110 may be controlled based on the assigned set of weights, the determined plurality of segregation parameters, the obtained ansatz and feature map, the obtained set of performance metrics, the obtained set of hardware details, and the obtained count value.

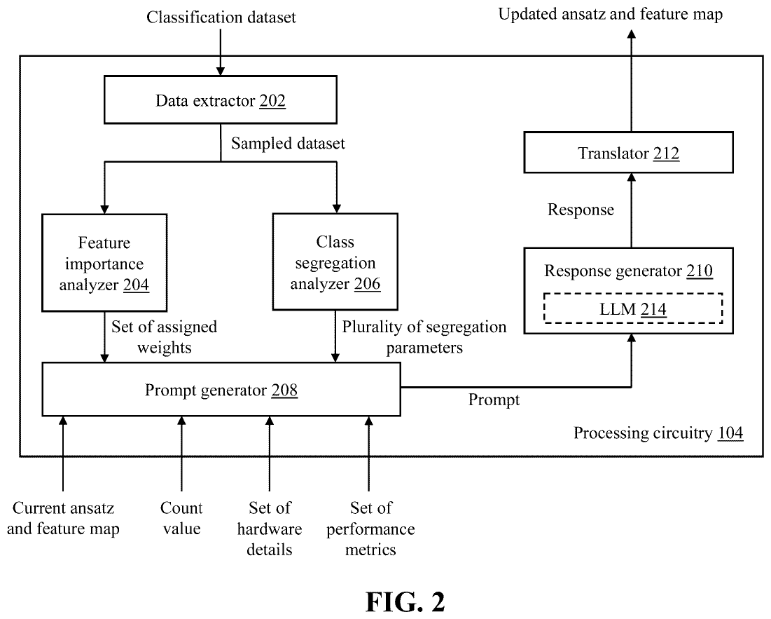

To control the iterative training of the VQC 110, the processing circuitry 104 may be further configured to update the current ansatz and the current feature map associated with the VQC 110 during each iteration. The update may be executed based on the weights, the segregation parameters, the current ansatz, the current feature map, the performance metrics, the hardware details, and the number of qubits. For example, the processing circuitry 104 may be configured to generate a prompt based on the assigned set of weights, the determined plurality of segregation parameters, the current ansatz and the current feature map associated with the VQC 110, the set of performance metrics of the VQC 110 for the current ansatz and the current feature map, the set of hardware details, and the count value. The processing circuitry 104 may be further configured to generate, using an LLM, a response to the generated prompt. In an embodiment, the generated response may correspond to the updated ansatz and the updated feature map. In another embodiment, the processing circuitry 104 may be further configured to translate the generated response to a format associated with the VQC 110. In such a scenario, the translated response may correspond to the updated ansatz and the update feature map. The updated ansatz and the updated feature map may be utilized in the next iteration of the VQC training to generate the VQC output. The processing circuitry 104 is explained in detail in conjunction with FIG. 2.

As the description of the classification dataset 108 is utilized for generating the prompt, the number of iterations required to achieve the desired performance of the VQC 110 may be significantly less than the number of iterations required for a conventional technique. Consequently, the computational cost associated with the VQC performance improvement technique of the present disclosure may be significantly less than that with the conventional technique. Thus, the trained VQC 110 may include the latest ansatz and feature map (e.g., versions of the ansatz and the feature map that have the highest value of the set of performance metrics).

Although it is described that both the feature map and the ansatz are updated during each iteration, the scope of the present disclosure is not limited to it. In numerous embodiments, exclusively the ansatz may be iteratively updated while the same feature map may be used for each iteration, without deviating from the scope of the present disclosure. In such a scenario, the response generated using the LLM or the translated response may exclusively correspond to the updated ansatz.

The scope of the present disclosure is not limited to the VQC training being controlled based on the assigned set of weights, the determined plurality of segregation parameters, the current ansatz and the current feature map, the set of performance metrics for the current ansatz and the current feature map, the set of hardware details, and the count value. In several embodiments, one or more of the aforementioned factors may be excluded from the VQC training control, without deviating from the scope of the present disclosure.

FIG. 2 is a block diagram of the processing circuitry 104, consistent with disclosed embodiments of the present disclosure. As illustrated in FIG. 2, the processing circuitry 104 may include a data extractor 202, a feature importance analyzer 204, a class segregation analyzer 206, a prompt generator 208, a response generator 210, and a translator 212.

The data extractor 202 may be communicatively coupled to the storage element 106. The data extractor 202 may include suitable logic, circuitry, interfaces, and/or code, executable by the circuitry, that may be configured to extract data from the classification dataset 108. For example, the data extractor 202 may be configured to obtain a sampled dataset from the classification dataset 108. In an embodiment, the sampled dataset may be obtained based on random sampling of the classification dataset 108. The data extractor 202 may be further configured to extract, from the classification dataset 108, the set of features and the plurality of classes. In an embodiment, the sampled dataset may indicate the set of features and the plurality of classes.

The feature importance analyzer 204 may be communicatively coupled to the data extractor 202. The feature importance analyzer 204 may include suitable logic, circuitry, interfaces, and/or code, executable by the circuitry, that may be configured to analyze the contribution of each feature in the class identification. The feature importance analyzer 204 may be configured to receive the sampled dataset from the data extractor 202 and execute a random forest operation on the sampled dataset. Based on the execution of the random forest operation, the feature importance analyzer 204 may be configured to assign the set of weights to the set of features. In an embodiment, each assigned weight corresponds to a Gini importance value. A weight is assigned to a feature based on the contribution of the corresponding feature in the identification of the plurality of classes. The importance of each feature may thus be utilized for optimizing the classification task.

In the classification task, for determining different patterns and complex relationships between the features in the classification dataset 108, understanding the combinations of features may be important. Some combinations may have a significant contribution in identifying the classes, whereas certain combinations may not. One of the reasons for different levels of contribution may be correlation of features. In the classification task, the combination of features that are highly correlated can significantly segregate the classes as compared to the combination of features having a weak correlation. Therefore, it may be important to determine the correlation between the set of features. This correlation may signify the ability to separate classes. In this regard, the class segregation analyzer 206 may be utilized in the processing circuitry 104

The class segregation analyzer 206 may be communicatively coupled to the data extractor 202. The class segregation analyzer 206 may include suitable logic, circuitry, interfaces, and/or code, executable by the circuitry, that may be configured to determine the correlation between the set of features. For example, the class segregation analyzer 206 may be configured to receive the sampled dataset from the data extractor 202 and determine a plurality of segregation parameters for the set of features. A segregation parameter, of the plurality of segregation parameters, may indicate a degree of separation between at least two classes, of the plurality of classes, based on a correlation between at least two features of the set of features. In an embodiment, the segregation parameter may correspond to a t-student parameter value. The higher the t-student parameter value, the higher the degree of separation between the two classes.

The set of weights and the plurality of segregation parameters can thus provide the description of the classification dataset 108. In an example, the classification dataset 108 corresponds to an Iris dataset. The Iris dataset may include a set of features, a set of instances, and a plurality of classes. The set of features may include sepal length, sepal width, petal length, and petal width. Each instance may include a set of values of the set of features. The plurality of classes may include three unique species of Iris flower, namely, Iris-setosa, Iris-versicolor, and Iris-virginica. The Iris dataset may be utilized to train the VQC 110 to classify the species of the Iris flower based on the sepal length, the sepal width, the petal length, and the petal width.

Each feature may contribute in a different manner to the identification of the Iris species. In other words, each of the sepal length, the sepal width, the petal length, and the petal width may have varying importance in identifying the Iris species. This importance can be represented as a weight. For example, the feature importance analyzer 204 may execute a random forest operation on a sampled Iris dataset and assign Gini importance values (e.g., weights) to the sepal length, the sepal width, the petal length, and the petal width. In an example, the petal length may have the highest importance, and hence, the highest assigned weight, whereas, the sepal width may have the lowest importance, and hence, the lowest assigned weight. Further, the petal width may have lower importance than the petal length but higher than the sepal length, and the sepal length may have higher importance than the sepal width. Thus, the ascending order of the assigned weights may be the sepal width, the sepal length, the petal width, and the petal length.

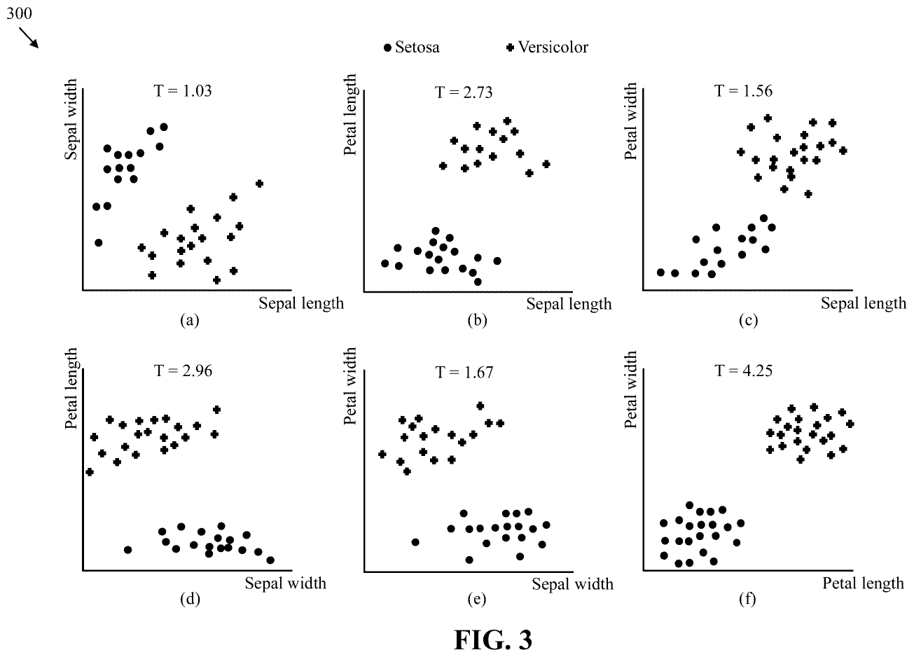

The correlation between different feature pairs may provide a degree of separation between classes. This degree of separation can be represented as a segregation parameter. For example, the class segregation analyzer 206 may analyze different combinations of the features and classes and determine a t-student parameter value (e.g., a segregation parameter) for each feature pair. In the Iris dataset, comprising four features and three classes, six feature pairs (e.g., sepal width—sepal length, petal length—sepal length, petal width—sepal length, petal length—sepal width, petal width—sepal width, and petal width—petal length) are possible. Each feature pair may be utilized for classifying two flower species. Thus, six t-student parameter values may be determined for separation between Iris-setosa and Iris-versicolor, six for separation between Iris-setosa and Iris-virginica, and six for separation between Iris-versicolor and Iris-virginica. For a different number of classes and features, the number of t-student parameter values may be different. The six t-student parameter values for the separation between Iris-setosa and Iris-versicolor are illustrated in FIG. 3.

To calculate the t-student parameter value for each feature pair, say petal length (pl) and petal width (pw), and each class pair, say Iris-setosa (S) and Iris-versicolor (V), in the classification dataset 108, the following parameters may be computed. Let M_{S} be the mean of the feature pair

$$( p {l}_{i}^{s} , p {w}_{i}^{s} ) ,$$

i=1, 2, . . . , n, that are in class S, and M_{V} be the mean of the feature pair

$$( p {l}_{i}^{V} , p {w}_{i}^{V} ) ,$$

i=1, 2, . . . , m, that are in class V.

The distance between the means is:

$$D = \sqrt{{( {M}_{S} - {M}_{V} )}^{2}}$$

To find out how the data points (pl, pw) in class S are distributed around the mean M_{S}, a value S_{S} is computed using:

$${S}_{S} = \sqrt{\frac{1}{n} {\sum }_{i = 1}^{n} {‖ {M}_{S} - ( p {l}_{i}^{S} , p {w}_{i}^{S} ) ‖}^{2}}$$

Similarly, a value S_{V} is computed for the class V.

Using D, S_{S}, and S_{V}, the t-student parameter value (T) for the petal length and the petal width indicating the degree of separation between Iris-setosa and Iris-versicolor is determined using:

$$T = \frac{D}{\sqrt{\frac{{S}_{S}^{2}}{n} + \frac{{S}_{V}^{2}}{m}}}$$

The higher the t-student parameter value, the higher the degree of class separation. In an example, for separation between Iris-setosa and Iris-versicolor, the t-student parameter values for the sepal width—sepal length feature pair may be 1.03, for the petal length—sepal length feature pair may be 2.73, for the petal width—sepal length feature pair may be 1.56, for the petal length—sepal width feature pair may be 2.96, for the petal width—sepal width feature pair may be 1.67, and for the petal width—petal length feature pair may be 4.25. Thus, the petal width—petal length feature pair may provide the highest degree of separation between Iris-setosa and Iris-versicolor. Similarly, for separation between Iris-setosa and Iris-virginica, the t-student parameter values for the sepal width—sepal length feature pair may be 1.35, for the petal length—sepal length feature pair may be 3.59, for the petal width—sepal length feature pair may be 2.27, for the petal length—sepal width feature pair may be 3.94, for the petal width—sepal width feature pair may be 2.27, and for the petal width—petal length feature pair may be 5.50. Thus, the petal width—petal length feature pair may provide the highest degree of separation between Iris-setosa and Iris-virginica. Additionally, for separation between Iris-versicolor and Iris-virginica, the t-student parameter values for the sepal width—sepal length feature pair may be 0.52, for the petal length—sepal length feature pair may be 0.95, for the petal width—sepal length feature pair may be 0.78, for the petal length—sepal width feature pair may be 1.10, for the petal width—sepal width feature pair may be 0.93, and for the petal width—petal length feature pair may be 1.32. Thus, the petal width—petal length feature pair may provide the highest degree of separation between Iris-versicolor and Iris-virginica.

The scope of the present disclosure is not limited to the classification dataset 108 including four features and three classes. In numerous embodiments, the number of features and classes may be different, without deviating from the scope of the present disclosure.

The prompt generator 208 may be communicatively coupled to the feature importance analyzer 204, the class segregation analyzer 206, the VQC 110, and the measurement circuit 112. The prompt generator 208 may include suitable logic, circuitry, interfaces, and/or code, executable by the circuitry, that may be configured to generate a contextually engineered prompt. The prompt generator 208 may be configured to obtain the assigned set of weights and the determined plurality of segregation parameters from the feature importance analyzer 204 and the class segregation analyzer 206, respectively. In the Iris dataset example, the prompt generator 208 may obtain four weights assigned to the four features and eighteen t-student parameter values from the feature importance analyzer 204 and the class segregation analyzer 206, respectively.

The prompt generator 208 may be further configured to obtain, from the VQC 110, the current ansatz associated with the VQC 110. In an embodiment, the prompt generator 208 may be further configured to obtain, from the VQC 110, the current feature map associated with the VQC 110. Further, the prompt generator 208 may be configured to obtain, from the measurement circuit 112, the set of performance metrics of the VQC 110 for the current ansatz and/or the current feature map. In an embodiment, the set of performance metrics may include an accuracy, a throughput, an efficiency, or the like, of the VQC 110.

The prompt generator 208 may be further configured to obtain, from the quantum processor 116 of the VQC 110, the set of hardware details of the hardware (e.g., the quantum processor 116) executing the VQC 110. In an embodiment, the set of hardware details may include a quantum gate type, a number of quantum parameters associated with a quantum gate, a number of quantum gates, a number of quantum layers, or the like. Further, the prompt generator 208 may be configured to obtain, from the quantum processor 116, the count value indicative of a number of qubits associated with the VQC 110. In an embodiment, the number of qubits associated with the VQC 110 may be a function of a number of features associated with the classification dataset 108. In the Iris dataset example, for four features, four qubits may be utilized.

The prompt generator 208 may be configured to generate a prompt based on the assigned set of weights, the determined plurality of segregation parameters, the current ansatz and the current feature map associated with the VQC 110, the set of performance metrics of the VQC 110 for the current ansatz and the current feature map, the set of hardware details, and the count value. In an embodiment, the prompt generator 208 may determine whether the set of performance metrics is within the desired range, prior to generating the prompt. In such a scenario, the prompt is generated exclusively when the set of performance metrics is not within the desired range.

Thus, in the present disclosure, a contextually engineered prompt is generated using the problem information (e.g., the current ansatz, the current feature map, and the count value), the current VQC performance metrics (e.g., the set of performance metrics), specification of the quantum hardware 102 (e.g., the set of hardware details) and a processed description of the classification dataset 108 (e.g., the assigned set of weights and the determined plurality of segregation parameters). Such a contextually engineered prompt is different from prompts generated in conventional VQC performance improvement techniques, and provides a higher degree of context associated with the problem statement (e.g., the classification task).

The response generator 210 may be communicatively coupled to the prompt generator 208. The response generator 210 may include suitable logic, circuitry, interfaces, and/or code, executable by the circuitry, that may be configured to receive the prompt from the prompt generator 208 and generate a response to the prompt. In an embodiment, the response generator 210 may include an LLM 214 that may be utilized for the response generation. Examples of the LLM 214 may include Generative Pre-trained Transformer (GPT)-3, GPT-4, Bidirectional Encoder Representations from Transformers (BERT), or the like.

In an embodiment, the LLM 214 may process the prompt to generate the response. For example, the LLM 214 may analyze the set of weights and the plurality of segregation parameters. Based on the assigned weights, the LLM 214 may determine the degree of manipulation of the associated qubits. Further, based on the t-student parameter values, the LLM 214 may identify the feature pairs that have significant and limited contributions to the classification task. For the feature pairs having lower t-student parameter values, the LLM 214 may determine different possibilities to improve the contribution. Other possibilities may correspond to the implementation of more gates, implementation of more layers, arrangement of the different types of gates in these layers, or the like. However, all these arrangements are confined to the availability of the hardware resources. The LLM 214 may utilize the set of hardware details to determine the availability of the hardware resources.

The response generated by the response generator 210 may be utilized for updating the ansatz and the feature map. The update of the ansatz may correspond to changes in the architecture and the parameters of the quantum circuit. Further, the update of the feature map may correspond to a change in the data encoding method. The generated response may not be in the format associated with the VQC 110. In such a scenario, the generated response may require translation.

Although it is described that the generated response is not in the format associated with the VQC 110, the scope of the present disclosure is not limited to it. In several embodiments, the generated response may be in the format associated with the VQC 110. In such a scenario, the generated response may correspond to the updated ansatz and the updated feature map.

The translator 212 may be communicatively coupled to the response generator 210 and the VQC 110. The translator 212 may include suitable logic, circuitry, interfaces, and/or code, executable by the circuitry, that may be configured to receive the response from the response generator 210 and translate the response to the format associated with the VQC 110. In such a scenario, the translated response may correspond to the updated ansatz and the update feature map. In an embodiment, the translator 212 may correspond to GPT-3. However, in other embodiments, different translators may be utilized.

The updated ansatz and the updated feature map may be utilized in the next iteration of the VQC training to generate the VQC output. Thus, for a subsequent iteration, the prompt may be generated based on the assigned set of weights, the determined plurality of segregation parameters, the updated ansatz and the updated feature map, the set of performance metrics of the VQC 110 for the updated ansatz and the updated feature map, the set of hardware details, and the count value. The iterative update may continue until the set of performance metrics is within the desired range. Thus, the trained VQC 110 may include the latest ansatz and feature map (e.g., versions of the ansatz and the feature map that have the highest value of the set of performance metrics).

Although it is described that both the feature map and the ansatz are updated during each iteration, the scope of the present disclosure is not limited to it. In numerous embodiments, exclusively the ansatz may be iteratively updated while the same feature map may be used for each iteration, without deviating from the scope of the present disclosure. In such a scenario, the response generated using the LLM 214 or the translated response may exclusively correspond to the updated ansatz.

The scope of the present disclosure is not limited to the iterative update continuing until the set of performance metrics is within the desired range. In additional embodiments, the iterative update may continue for a predefined number of iterations, without deviating from the scope of the present disclosure. In such a scenario, the trained VQC 110 may include versions of the ansatz and the feature map that have the highest value of the set of performance metrics.

FIG. 3 illustrates an example implementation 300 of segregation parameters for four features and two classes, consistent with disclosed embodiments of the present disclosure. Referring to FIG. 3, scatter plots (a)-(f) with corresponding t-student parameter values (T) for four features and two classes, are shown. In the Iris dataset example, the degree of separation of Iris-setosa and Iris-versicolor based on the sepal width—sepal length feature pair, the petal length—sepal length feature pair, the petal width—sepal length feature pair, the petal length—sepal width feature pair, the petal width—sepal width feature pair, and the petal width—petal length feature pair are illustrated.

As illustrated in the scatter plot (a), the t-student parameter value for the sepal width—sepal length feature pair is 1.03. The t-student parameter value indicates the degree of separation of Iris-setosa and Iris-versicolor based on the correlation between sepal width and sepal length. Similarly, scatter plots (b) through (f) illustrate the t-student parameter values for different feature pairs. For example, the scatter plot (b) illustrates that the t-student parameter value for the petal length—sepal length feature pair is 2.73. Further, the scatter plot (c) illustrates that the t-student parameter value for the petal width—sepal length feature pair is 1.56, and the scatter plot (d) illustrates that the t-student parameter value for the petal length—sepal width feature pair is 2.96. Additionally, the scatter plot (e) illustrates that the t-student parameter value for the petal width—sepal width feature pair is 1.67, and the scatter plot (f) illustrates that the t-student parameter value for the petal width—petal length feature pair is 4.25.

As shown, the higher the t-student parameter value, the clearer the distinction between the two classes. Thus, the feature pair with the highest t-student parameter value, e.g., the petal width—petal length feature pair, effectively contributes to the performance improvement of the VQC 110. The t-student parameter values may thus be effective in the update of the ansatz and the feature map.

For the Iris dataset, six scatter plots for separation between Iris-setosa and Iris-virginica and six scatter plots for separation between Iris-versicolor and Iris-virginica may similarly illustrate corresponding t-student parameter values.

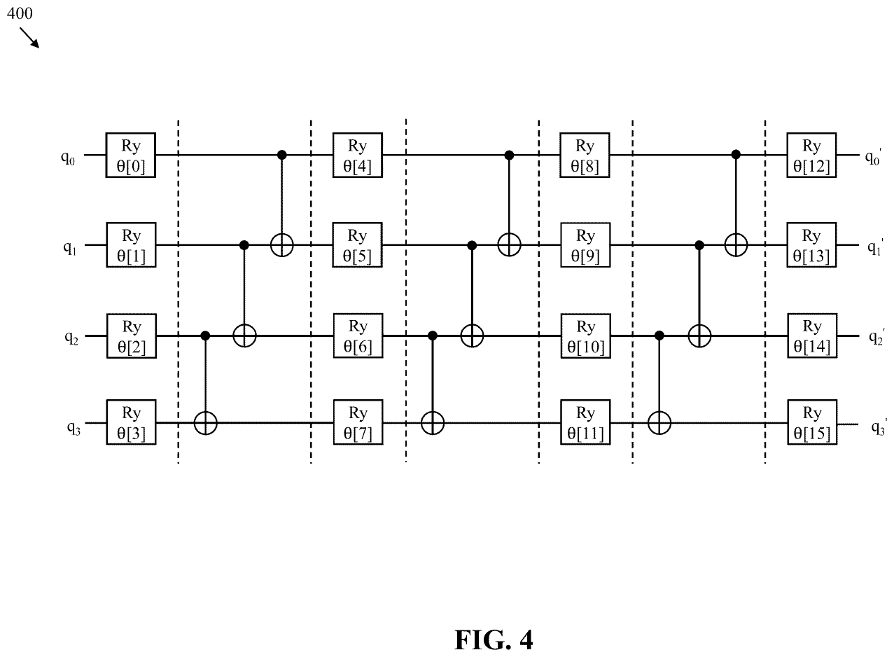

FIG. 4 is a block diagram 400 of a real-amplitude ansatz utilized for an initial iteration of training of the VQC 110, consistent with disclosed embodiments of the present disclosure. Referring to FIG. 4, the real-amplitude ansatz with 4 qubits is illustrated. Each qubit may represent a feature of the set of features. For example, qubit q₀ may represent the sepal length feature, qubit q₁ may represent the sepal width feature, qubit q₂ may represent the petal length feature, and qubit q₃ may represent the petal width feature. The real-amplitude ansatz may include multiple quantum gates that operate on the qubits.

The quantum circuit represented in FIG. 4 includes quantum rotational gates (Ry[θ], where “θ” is a real value parameter (e.g., an angle of rotation)). The rotational gates in the real-amplitude ansatz may rotate the qubits around the Y-axis by an angle θ. The quantum circuit represented in FIG. 4 may also include controlled-NOT gates (represented by ⊕). The controlled-NOT gate is a type of NOT gate which performs the NOT operation only under a specific condition. If the specific condition is not met, the controlled-NOT gate does not perform any operation and just passes through the input qubit without any modification. The controlled-NOT gate has two input pins and two output pins. The first pin (e.g., the upper input pin) is called a control pin that determines whether the gate should perform NOT operation or not and the second input (e.g., the lower input pin) indicates the bit that is the target for NOT operation. The quantum rotational gates and the controlled NOT gates are executed on the four qubits in the manner illustrated in FIG. 4 and the encoded qubits q₀′-q₃′ are obtained.

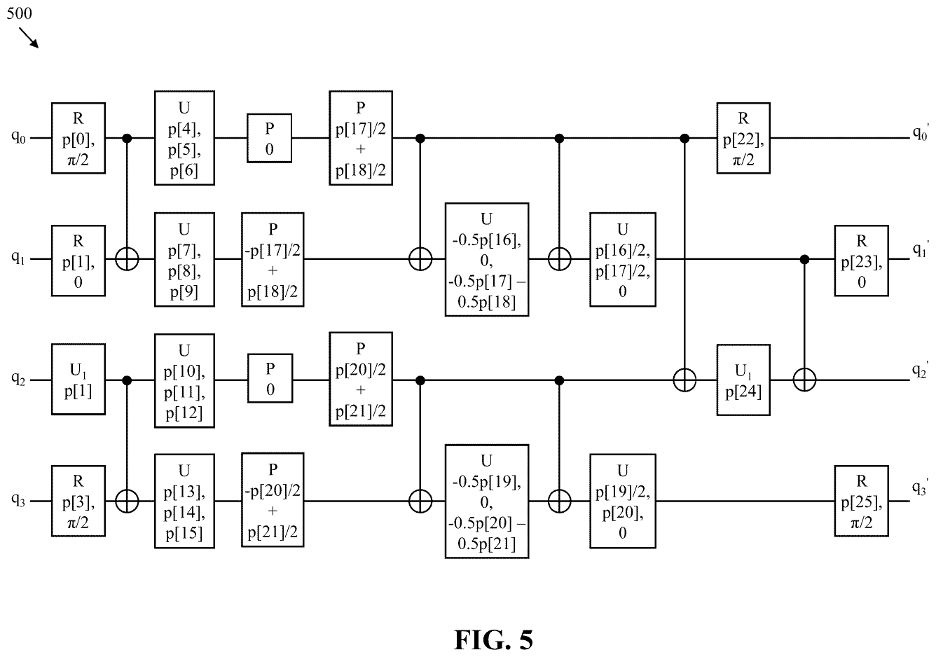

During the initial iteration, the set of performance metrics of the VQC 110 is determined based on the real-amplitude ansatz. For performance improvement of the VQC 110, the architecture and the parameters of the real-amplitude ansatz are updated. One example of the updated ansatz is illustrated in FIG. 5.

FIG. 5 is a block diagram 500 of an updated ansatz utilized for the last iteration of the training of the VQC, consistent with disclosed embodiments of the present disclosure. Referring to FIG. 5, the updated ansatz with 4 qubits is illustrated. Each qubit may represent a feature of the set of features. For example, qubit q₀ may represent the sepal length feature, qubit q₁ may represent the sepal width feature, qubit q₂ may represent the petal length feature, and qubit q₃ may represent the petal width feature. The updated ansatz may include multiple quantum gates that operate on the qubits.

The quantum circuit represented in FIG. 5 includes the quantum rotational gates R and the controlled-NOT gates. The quantum circuit represented in FIG. 5 may also include universal single-qubit gates (U). The universal single-qubit gate can be parameterized using three angles, θ, φ, and λ. The universal single-qubit gate applies a unitary transformation to the qubit, thereby changing its state. The transformation can be represented by a 2*2 matrix that rotates the qubit on the Bloch sphere:

$$U ( θ , ϕ , λ ) = ( \begin{matrix}cos ( \frac{θ}{2} ) & - {e}^{i λ} sin ( \frac{θ}{2} ) \\ {e}^{i ϕ} sin ( \frac{θ}{2} ) & {e}^{i ( ϕ + λ )} cos ( \frac{θ}{2} )\end{matrix} )$$

where,
θ controls the rotation of qubit on the Bloch sphere,
φ controls the phase shift before the rotation, and
λ controls the phase shift after the rotation.

By adjusting the θ, φ, λ, the qubit state can be changed.

FIG. 5 may also include phase gate (P). It is represented as P(φ) or S. The phase gate adds a phase shift to the qubit's state for precise adjustments. The phase gate P(φ) is represented by the following matrix:

$$P ( ϕ ) = ( \begin{matrix}1 & 0 \\ 0 & {e}^{i ϕ}\end{matrix} )$$

where,
φ is the phase angle

If the qubit is in the state 0, it remains unchanged, whereas if the qubit state is in the state 1, it gains a phase factor e^{iφ}.

The quantum rotational gates, the controlled-NOT gates, the universal single-qubit gates, and the phase gates are executed on the four qubits in the manner illustrated in FIG. 5 and the encoded qubits q₀′-q₃′ are obtained.

Although FIG. 5 illustrates the quantum rotational gates, the controlled-NOT gates, the universal single-qubit gates, and the phase gates, the scope of the present disclosure is not limited to it. In several embodiments, the utilization of these gates depends on the set of hardware details of the hardware (e.g., the quantum processor 116) executing the VQC 110.

The updated ansatz, illustrated in FIG. 5 may represent the latest ansatz (e.g., the version of the ansatz that has the highest value of the set of performance metrics).

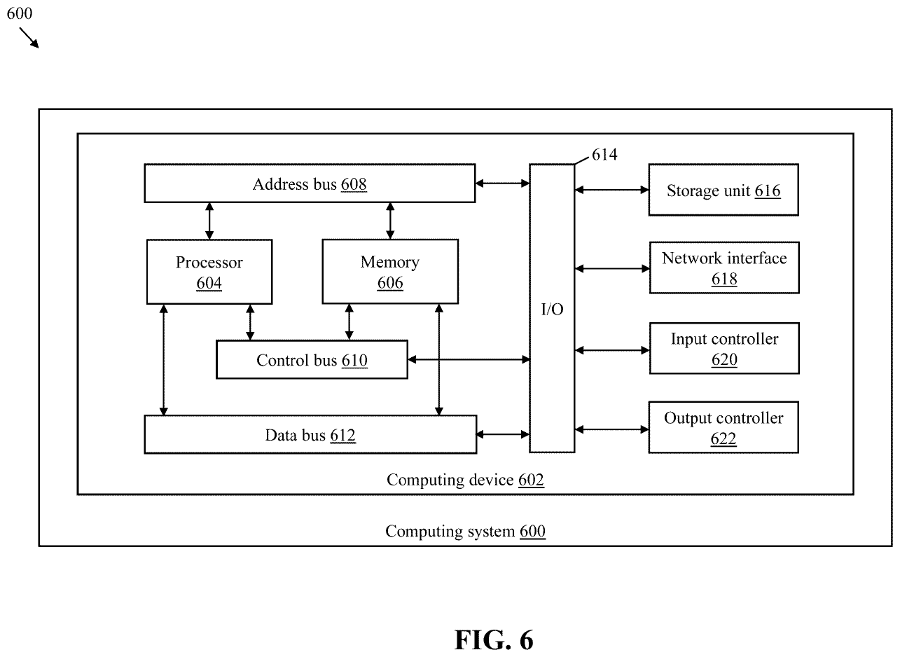

FIG. 6 shows an example computing system 600 for carrying out the methods of the present disclosure, consistent with disclosed embodiments of the present disclosure. Specifically, FIG. 6 shows a block diagram of an embodiment of the computing system 600 according to example embodiments of the present disclosure.

The computing system 600 may be configured to perform any of the operations disclosed herein. The computing system 600 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 600 is a distributed system configured to function using multiple computing machines interconnected via a data network or bus system.

The computing system 600 includes computing devices (such as a computing device 602). The computing device 602 includes one or more processors (such as a processor 604) and a memory 606. The processor 604 may be any general-purpose processor(s) configured to execute a set of instructions. For example, the processor 604 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 604 may be multiple processing units, a single processing core, multiple processing cores, special purpose processing cores, co-processors, or any combination thereof. The processor 604 may be communicatively coupled to the memory 606 via an address bus 608, a control bus 610, and a data bus 612.

The memory 606 may include non-volatile memories such as a read-only memory (ROM), a programable read-only memory (PROM), an erasable programmable read-only memory (EPROM), a flash memory, or any other device capable of storing program instructions or data with or without applied power. The memory 606 may also include volatile memories, such as a random-access-memory (RAM), a static random-access-memory (SRAM), a dynamic random-access-memory (DRAM), and a synchronous dynamic random-access-memory (SDRAM). The memory 606 may include single or multiple memory modules. While the memory 606 is depicted as part of the computing device 602, a person skilled in the art will recognize that the memory 606 can be separate from the computing device 602.

The memory 606 may store information that can be accessed by the processor 604. For instance, the memory 606 (e.g., one or more non-transitory computer-readable storage mediums, memory devices) may include computer-readable instructions (not shown) that can be executed by the processor 604. The computer-readable instructions may be software written in any suitable programming language or may be implemented in hardware. Additionally, or alternatively, the computer-readable instructions may be executed in logically and/or virtually separate threads on the processor 604. For example, the memory 606 may store instructions (not shown) that when executed by the processor 604 cause the processor 604 to perform operations such as any of the operations and functions for which the computing system 600 is configured, as described herein. Additionally, or alternatively, the memory 606 may store data (not shown) that can be obtained, received, accessed, written, manipulated, created, and/or stored. The data can include, for instance, the data and/or information described herein in relation to FIGS. 1 and 2. In some implementations, the computing device 602 may obtain from and/or store data in one or more memory device(s) that are remote from the computing system 600.

The computing device 602 may further include an input/output (I/O) interface 614 communicatively coupled to the address bus 608, the control bus 610, and the data bus 612. The data bus 612 may include a plurality of tunnels that may support communication in the VQC system 100. The I/O interface 614 is configured to couple to one or more external devices (e.g., to receive and send data from/to one or more external devices). Such external devices, along with the various internal devices, may also be known as peripheral devices. The I/O interface 614 may include both electrical and physical connections for operably coupling the various peripheral devices to the computing device 602. The I/O interface 614 may be configured to communicate data, addresses, and control signals between the peripheral devices and the computing device 602. The I/O interface 614 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 614 is configured to implement only one interface or bus technology. Alternatively, the I/O interface 614 is configured to implement multiple interfaces or bus technologies. The I/O interface 614 may include one or more buffers for buffering transmissions between one or more external devices, internal devices, the computing device 602, or the processor 604. The I/O interface 614 may couple the computing device 602 to various input devices, including mice, touch screens, scanners, biometric readers, electronic digitizers, sensors, receivers, touchpads, trackballs, cameras, microphones, keyboards, any other pointing devices, or any combinations thereof. The I/O interface 614 may couple the computing device 602 to various output devices, including video displays, speakers, printers, projectors, tactile feedback devices, automation control, robotic components, actuators, motors, fans, solenoids, valves, pumps, transmitters, signal emitters, lights, and so forth.

The computing system 600 may further include a storage unit 616, a network interface 618, an input controller 620, and an output controller 622. The storage unit 616, the network interface 618, the input controller 620, and the output controller 622 are communicatively coupled to the central control unit (e.g., the memory 606, the address bus 608, the control bus 610, and the data bus 612) via the I/O interface 614. The network interface 618 communicatively couples the computing system 600 to one or more networks such as wide area networks (WAN), local area networks (LAN), intranets, the Internet, wireless access networks, wired networks, mobile networks, telephone networks, optical networks, or combinations thereof. The network interface 618 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 616 is a computer-readable medium, preferably a non-transitory computer-readable medium, comprising one or more programs, the one or more programs comprising instructions which when executed by the processor 604 cause the computing system 600 to perform the method steps of the present disclosure. Alternatively, the storage unit 616 is a transitory computer-readable medium. The storage unit 616 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 616 stores one or more operating systems, application programs, program modules, data, or any other information. The storage unit 616 is part of the computing device 602. Alternatively, the storage unit 616 is part of one or more other computing machines that are in communication with the computing device 602, such as servers, database servers, cloud storage, network attached storage, and so forth.

The input controller 620 may include suitable logic, circuitry, interfaces, and/or code, executable by the circuitry, that may be configured to control one or more input devices that may be configured to receive an input for the VQC system 100. The output controller 622 may include suitable logic, circuitry, interfaces, and/or code, executable by the circuitry, that may be configured to control one or more output devices that may be configured to render/output the outcome of the operation executed to process the received input.

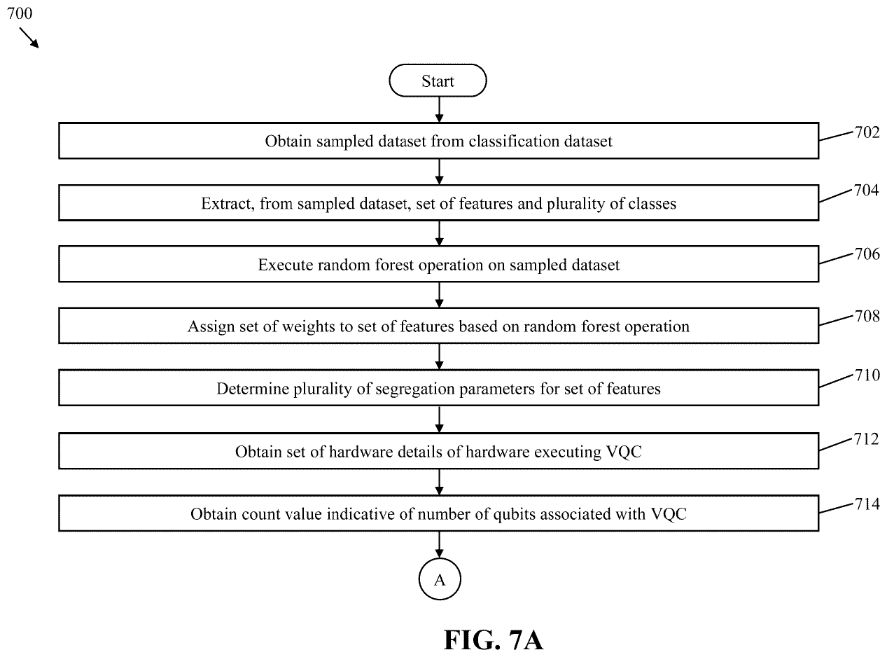

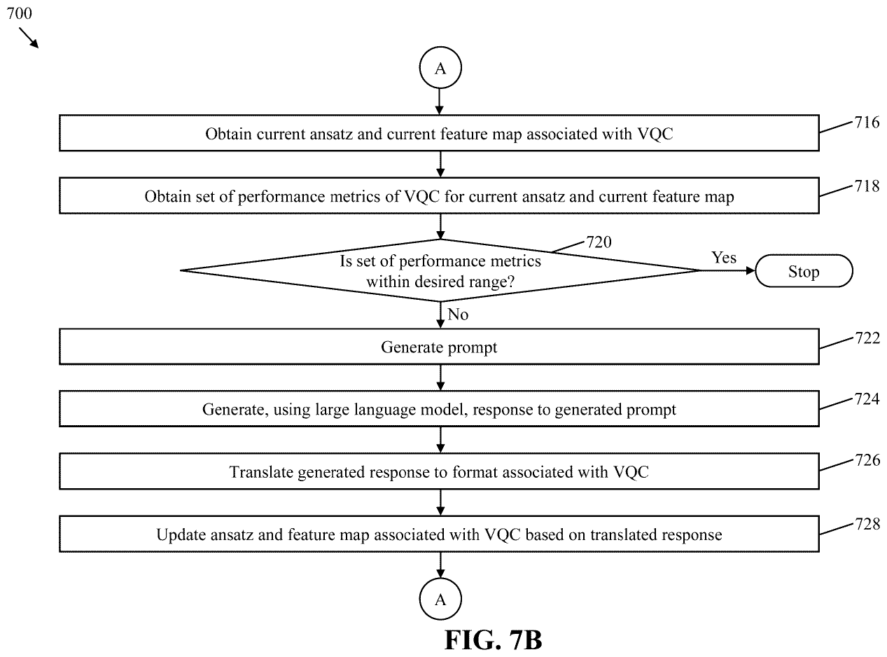

FIGS. 7A and 7B collectively, represents a flowchart 700 that illustrates a method for performance improvement of the VQC 110, consistent with disclosed embodiments of the present disclosure.

Referring to FIG. 7A, at 702, the processing circuitry 104 (e.g., the data extractor 202) may obtain the sampled dataset from the classification dataset 108. At 704, the processing circuitry 104 (e.g., the data extractor 202) may extract, from the sampled dataset, the set of features and the plurality of classes.

At 706, the processing circuitry 104 (e.g., the feature importance analyzer 204) may execute the random forest operation on the sampled dataset. At 708, the processing circuitry 104 (e.g., the feature importance analyzer 204) may assign the set of weights to the set of features based on the random forest operation. A weight, of the set of weights, is assigned to a feature, of the set of features, based on a contribution of the corresponding feature in the identification of the plurality of classes.

At 710, the processing circuitry 104 (e.g., the class segregation analyzer 206) may determine the plurality of segregation parameters for the set of features. A segregation parameter, of the plurality of segregation parameters, may indicate a degree of separation between at least two classes, of the plurality of classes, based on a correlation between at least two features of the set of features.

At 712, the processing circuitry 104 (e.g., the prompt generator 208) may obtain a set of hardware details of the hardware executing the VQC 110. The set of hardware details may include a quantum gate type, a number of quantum parameters associated with a quantum gate, a number of quantum gates, and a number of quantum layers. At 714, the processing circuitry 104 (e.g., the prompt generator 208) may obtain a count value indicative of the number of qubits associated with the VQC 110.

Referring to FIG. 7B, at 716, the processing circuitry 104 (e.g., the prompt generator 208) may obtain the current ansatz and the current feature map associated with the VQC 110. At 718, the processing circuitry 104 (e.g., the prompt generator 208) may obtain the set of performance metrics of the VQC 110 for the current ansatz and the current feature map.

At 720, the processing circuitry 104 (e.g., the prompt generator 208) may determine whether the set of performance metrics is within the desired range. If at 720, it is determined that the set of performance metrics is not within the desired range, 722 is executed. At 722, the processing circuitry 104 (e.g., the prompt generator 208) may generate the prompt. The prompt may be generated based on the assigned set of weights, the determined plurality of segregation parameters, the current ansatz and the current feature map associated with the VQC 110, the set of performance metrics of the VQC 110 for the current ansatz and the current feature map, the set of hardware details, and the count value. At 724, the processing circuitry 104 (e.g., the response generator 210) may generate, using an LLM (e.g., the LLM 214), the response to the generated prompt. At 726, the processing circuitry 104 (e.g., the translator 212) may translate the generated response to a format associated with the VQC 110. At 728, the processing circuitry 104 (e.g., the translator 212) may update the ansatz and the feature map associated with the VQC 110 based on the translated response. In an example, the processing circuitry 104 (e.g., the translator 212) may provide the translated response to the VQC 110 (e.g., the data encoder 114 and the quantum processor 116) to update the ansatz and the feature map associated with the VQC 110. 716 is executed after 728.

Conversely, if at 720, it is determined that the set of performance metrics is within the desired range, the training of the VQC 110 is complete. In such a scenario, the trained VQC 110 may include the latest ansatz and feature map (e.g., versions of the ansatz and the feature map that have the highest value of the set of performance metrics).

The disclosed embodiments encompass numerous advantages including an efficient and seamless approach for performance improvement of VQCs using LLMs. The systems and methods disclosed herein allow for the generation of a contextually engineered prompt. As the prompt comprises the description of the classification dataset 108, the number of iterations required to achieve the desired performance metrics may be significantly less than the number of iterations required for the conventional technique. With a marked decrease in iterations, the computational cost associated with the VQC performance improvement technique of the present disclosure may be significantly less than that with the conventional technique. Additionally, the VQC performance improvement technique of the present disclosure may preserve human intervention based prompt tuning. Thus, human errors are avoided leading to a further increase in the VQC performance, specifically in terms of classification accuracy. The application area of the present disclosure may include any domain that utilizes pattern identification, risk analysis, power optimization, or the like.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for performance improvement of VQCs using LLMs. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:

1. A system, comprising:
processing circuitry that is configured to:
   extract, from a classification dataset, a set of features and a plurality of classes that are identified based on the set of features, wherein a variational quantum classifier (VQC) is iteratively trained based on the classification dataset;
   assign a set of weights to the set of features, wherein a weight, of the set of weights, is assigned to a feature, of the set of features, based on a contribution of the corresponding feature in the identification of the plurality of classes; and
   determine a plurality of segregation parameters for the set of features, wherein a segregation parameter, of the plurality of segregation parameters, indicates a degree of separation between at least two classes, of the plurality of classes, based on a correlation between at least two features of the set of features, and wherein the iterative training of the VQC is controlled based on the assigned set of weights and the determined plurality of segregation parameters.
      2. The system of 1, wherein the processing circuitry is further configured to obtain a current ansatz associated with the VQC and a set of performance metrics of the VQC for the current ansatz, and wherein the iterative training of the VQC is controlled further based on the obtained ansatz and the obtained set of performance metrics.
      3. The system of 2, wherein during an iteration of the VQC training, based on the current ansatz and the classification dataset, an output of the VQC is generated, and the set of performance metrics is determined based on a comparison of the generated output with a target output of the classification dataset.
      4. The system of 1, wherein the processing circuitry is further configured to obtain a set of hardware details of hardware executing the VQC, and wherein the iterative training of the VQC is controlled further based on the obtained set of hardware details.
      5. The system of 4, wherein the set of hardware details comprises at least one of a group consisting of a quantum gate type, a number of quantum parameters associated with a quantum gate, a number of quantum gates, and a number of quantum layers.
      6. The system of 1, wherein the processing circuitry is further configured to obtain a count value indicative of a number of qubits associated with the VQC, and wherein the iterative training of the VQC is controlled further based on the obtained count value.
      7. The system of 6, wherein the number of qubits associated with the VQC is a function of a number of features associated with the classification dataset.
      8. The system of 1, wherein to control the iterative training of the VQC, the processing circuitry is further configured to update, based on the assigned set of weights and the determined plurality of segregation parameters, an ansatz associated with the VQC during each iteration.
      9. The system of 8, wherein the processing circuitry is further configured to generate a prompt based on at least one of a group consisting of the assigned set of weights, the determined plurality of segregation parameters, a current ansatz associated with the VQC, a set of performance metrics of the VQC for the current ansatz, a set of details of hardware executing the VQC, and a count value indicative of a number of qubits associated with the VQC.
      10. The system of 9, wherein the processing circuitry is further configured to generate, using a large language model, a response to the generated prompt, and wherein the generated response corresponds to the updated ansatz.
      11. The system of 9, wherein the processing circuitry is further configured to generate, using a large language model, a response to the generated prompt and translate the generated response to a format associated with the VQC, and wherein the translated response corresponds to the updated ansatz.
      12. The system of 8, wherein during an initial iteration of the training of the VQC, the ansatz associated with the VQC corresponds to a real-amplitude ansatz.
      13. The system of 8, wherein the trained VQC comprises a version of the ansatz having the highest value of a set of performance metrics of the VQC.
      14. The system of 1, wherein the processing circuitry is further configured to obtain a sampled dataset from the classification dataset.
      15. The system of 14, wherein to assign the set of weights to the set of features, the processing circuitry is further configured to execute a random forest operation on the sampled dataset.
      16. The system of 1, wherein the assigned weight corresponds to a Gini importance value.
      17. The system of 1, wherein the segregation parameter corresponds to a t-student parameter value.
      18. The system of 1, wherein the processing circuitry is further configured to obtain a current feature map associated with the VQC, and wherein the iterative training of the VQC is controlled further based on the obtained feature map.
      19. The system of 1, wherein to control the iterative training of the VQC, the processing circuitry is further configured to update, based on the assigned set of weights and the determined plurality of segregation parameters, an ansatz and a feature map associated with the VQC during each iteration.
      20. The system of 19, wherein the processing circuitry is further configured to generate a prompt based on at least one of a group consisting of the assigned set of weights, the determined plurality of segregation parameters, a current ansatz and a current feature map associated with the VQC, a set of performance metrics of the VQC for the current ansatz and the current feature map, a set of hardware details of hardware executing the VQC, and a count value indicative of a number of qubits associated with the VQC.
      21. The system of 20, wherein the processing circuitry is further configured to generate, using a large language model, a response to the generated prompt, and wherein the generated response corresponds to the updated ansatz and the updated feature map.
      22. The system of 20, wherein the processing circuitry is further configured to generate, using a large language model, a response to the generated prompt and translate the generated response to a format associated with the VQC, and wherein the translated response corresponds to the updated ansatz and the updated feature map.
      23. The system of 19, wherein during an initial iteration of the training of the VQC, the feature map associated with the VQC corresponds to a ZZ feature map.
      24. A method, comprising:
extracting, by processing circuitry, from a classification dataset, a set of features and a plurality of classes that are identified based on the set of features, wherein a variational quantum classifier (VQC) is iteratively trained based on the classification dataset;
assigning, by the processing circuitry, a set of weights to the set of features, wherein a weight, of the set of weights, is assigned to a feature, of the set of features, based on a contribution of the corresponding feature in the identification of the plurality of classes; and
determining, by the processing circuitry, a plurality of segregation parameters for the set of features, wherein a segregation parameter, of the plurality of segregation parameters, indicates a degree of separation between at least two classes, of the plurality of classes, based on a correlation between at least two features of the set of features, and wherein the iterative training of the VQC is controlled based on the assigned set of weights and the determined plurality of segregation parameters.

What is claimed is:

1. A system, comprising:
processing circuitry that is configured to:
extract, from a classification dataset, a set of features and a plurality of classes that are identified based on the set of features, wherein a variational quantum classifier (VQC) is iteratively trained based on the classification dataset;
assign a set of weights to the set of features, wherein a weight, of the set of weights, is assigned to a feature, of the set of features, based on a contribution of the corresponding feature in the identification of the plurality of classes; and
determine a plurality of segregation parameters for the set of features, wherein a segregation parameter, of the plurality of segregation parameters, indicates a degree of separation between at least two classes, of the plurality of classes, based on a correlation between at least two features of the set of features, and wherein the iterative training of the VQC is controlled based on the assigned set of weights and the determined plurality of segregation parameters.

2. The system of claim 1,
wherein the processing circuitry is further configured to obtain a current ansatz associated with the VQC and a set of performance metrics of the VQC for the current ansatz, and
wherein the iterative training of the VQC is controlled further based on the obtained ansatz and the obtained set of performance metrics.

3. The system of claim 2, wherein during an iteration of the VQC training, based on the current ansatz and the classification dataset, an output of the VQC is generated, and the set of performance metrics is determined based on a comparison of the generated output with a target output of the classification dataset.

4. The system of claim 1,
wherein the processing circuitry is further configured to obtain a set of hardware details of hardware executing the VQC, and
wherein the iterative training of the VQC is controlled further based on the obtained set of hardware details.

5. The system of claim 4, wherein the set of hardware details comprises at least one of a group consisting of a quantum gate type, a number of quantum parameters associated with a quantum gate, a number of quantum gates, and a number of quantum layers.

6. The system of claim 1,
wherein the processing circuitry is further configured to obtain a count value indicative of a number of qubits associated with the VQC, and
wherein the iterative training of the VQC is controlled further based on the obtained count value.

7. The system of claim 6, wherein the number of qubits associated with the VQC is a function of a number of features associated with the classification dataset.

8. The system of claim 1, wherein to control the iterative training of the VQC, the processing circuitry is further configured to update, based on the assigned set of weights and the determined plurality of segregation parameters, an ansatz associated with the VQC during each iteration.

9. The system of claim 8, wherein the processing circuitry is further configured to generate a prompt based on at least one of a group consisting of:
the assigned set of weights,
the determined plurality of segregation parameters,
a current ansatz associated with the VQC,
a set of performance metrics of the VQC for the current ansatz,
a set of details of hardware executing the VQC, and
a count value indicative of a number of qubits associated with the VQC.

10. The system of claim 9, wherein the processing circuitry is further configured to generate, using a large language model, a response to the generated prompt, and wherein the generated response corresponds to the updated ansatz.

11. The system of claim 9, wherein the processing circuitry is further configured to:
generate, using a large language model, a response to the generated prompt; and
translate the generated response to a format associated with the VQC, wherein the translated response corresponds to the updated ansatz.

12. The system of claim 8, wherein during an initial iteration of the training of the VQC, the ansatz associated with the VQC corresponds to a real-amplitude ansatz.

13. The system of claim 8, wherein the trained VQC comprises aversion of the ansatz having the highest value of a set of performance metrics of the VQC.

14. The system of claim 1, wherein the processing circuitry is further configured to obtain a sampled dataset from the classification dataset.

15. The system of claim 14, wherein to assign the set of weights to the set of features, the processing circuitry is further configured to execute a random forest operation on the sampled dataset.

16. The system of claim 1, wherein the weight corresponds to a Gini importance value.

17. The system of claim 1, wherein the segregation parameter corresponds to a t-student parameter value.

18. The system of claim 1,
wherein the processing circuitry is further configured to obtain a current feature map associated with the VQC, and
wherein the iterative training of the VQC is controlled further based on the obtained feature map.

19. The system of claim 1, wherein to control the iterative training of the VQC, the processing circuitry is further configured to update, based on the assigned set of weights and the determined plurality of segregation parameters, an ansatz and a feature map associated with the VQC during each iteration.

20. A method, comprising:
extracting, by processing circuitry, from a classification dataset, a set of features and a plurality of classes that are identified based on the set of features, wherein a variational quantum classifier (VQC) is iteratively trained based on the classification dataset;
assigning, by the processing circuitry, a set of weights to the set of features, wherein a weight, of the set of weights, is assigned to a feature, of the set of features, based on a contribution of the corresponding feature in the identification of the plurality of classes; and
determining, by the processing circuitry, a plurality of segregation parameters for the set of features, wherein a segregation parameter, of the plurality of segregation parameters, indicates a degree of separation between at least two classes, of the plurality of classes, based on a correlation between at least two features of the set of features, and wherein the iterative training of the VQC is controlled based on the assigned set of weights and the determined plurality of segregation parameters.
